(19) United States
(12) Patent Application Publication
(10) Pub. No.: US 2010/0101740 A1
(43) Pub. Date: Apr. 29, 2010

(54) CONNECTOR

(76) Inventor: Carmelo Joseph Licciardi Di Stefano, Victoria (AU)

Correspondence Address: HEAD, JOHNSON & KACHIGIAN, 228 W 17TH PLACE, TULSA, OK, 74119, US

(21) Appl. No.: 12/451,541

(22) PCT Filed: May 22, 2008
(86) PCT No.: PCT/AU2008/000722

§ 371 Date: Nov. 16, 2009

(30) Foreign Application Priority Data
May 24, 2007 (AU) 2007902784

(51) Int. Cl. E06B 9/56

(52) U.S. Cl. 160/309

(57) ABSTRACT

A connector for a blind control mechanism including a cylinder rotatable relative to two or more different shafts, drive means connected to the cylinder and being operable to rotate the cylinder in either a blind extending direction or a blind retracting direction; at least two biasing means connected to the cylinder, each biasing means being responsive to rotation of the cylinder in a blind extending direction to store energy and being responsive to rotation of the cylinder in a blind retracting direction to release the stored energy and thereby apply a turning force to the cylinder, the turning force acting in the blind retraction direction. The connector having a body for coupling an end portion of one of the biasing means to one of the shaft portions and for coupling respective end portions of two adjacent the shafts together.

### FIELD

The present invention relates to a connector, such as, but not being limited to, a connector for extending a shaft in window furnishings.

### BACKGROUND

Roller blind systems typically include a tube with sheet material (e.g. fabric) rolled around the tube. The tube is held in a fixed position, and is rotated to raise or lower the material, for example, over a windowed area to serve as a blind. A weight may be attached to one end of the material to assist in lowering the blind. The inside of the tube may be fitted with a booster assembly, which includes a spring having one end held in a fixed position relative to tube, and a component that engages the other end of the spring for rotation with the tube. As the blind is lowered, the spring is made to tighten to provide a counterbalancing (generally upward) force to assist in raising the blind.

For blinds made of a heavy material, the counterbalancing force provided by one booster assembly may not be sufficient for effectively or conveniently raising the blind. A similar problem exists where a larger roller blind (i.e. of greater span) is required to extend over a larger windowed area, since a larger blind increases its overall weight and the counterbalancing force exerted by a single spring booster assembly may not be sufficient for effective/convenient retraction of the blind. Another problem is the impracticality of manufacturing shafts at custom lengths, and to custom make and fit booster assemblies onto such a shaft. Custom manufacture and fitting is laborious and hence an expensive option. It is therefore desired to address one or more of the above issues, or to at least provide a useful alternative.

### SUMMARY

According to the present invention there is provided a connector for a blind control mechanism, said mechanism including:
i) a cylinder rotatable relative to two or more different shafts;
ii) drive means connected to the cylinder and being operable to rotate the cylinder in either a blind extending direction or a blind retracting direction; and
iii) at least two biasing means connected to said cylinder, each said biasing means being responsive to rotation of the cylinder in a blind extending direction to store energy and being responsive to rotation of said cylinder in a blind retracting direction to release said stored energy and thereby apply a turning force to the cylinder, said turning force acting in the blind retracting direction;
   said connector having a body for coupling an end portion of one of said biasing means to one of said shaft portions, and for coupling respective end portions of two adjacent said shafts together.

The present invention also provides a connector for a blind control mechanism, said mechanism including:
i) a cylinder rotatable relative to two or more different shaft portions;
ii) drive means connected to the cylinder and being operable to rotate the cylinder in either a blind extending direction or a blind retracting direction; and
iii) at least two biasing means connected to said cylinder, each said biasing means being responsive to rotation of the cylinder in a blind extending direction to store energy and being responsive to rotation of said cylinder in a blind retracting direction to release said stored energy and thereby apply a turning force to the cylinder, said turning force acting in the blind retracting direction;
   said connector having a body for coupling an end portion of one of said biasing means to one of said shaft portions, said connector having an end portion formed for connecting with another of said shaft portions located on a separate shaft.

The present invention also provides an assembly for use in window furnishings including a connector as described above.

### BRIEF DESCRIPTION OF THE DRAWINGS

A preferred embodiment of the present invention is herein described, by way of example only, with reference to the accompanying drawings, wherein:

FIG. 1 is a perspective view of two spring booster assemblies;

FIG. 2 is an exploded perspective view of a spring booster assembly including a connector according to a first embodiment;

FIG. 3 is an exploded side view of a spring booster assembly including a connector according to a first embodiment;

FIG. 4 is a perspective view of two spring booster assemblies;

FIG. 5 is an exploded perspective view of a spring booster assembly including a connector according to a second embodiment;

FIG. 6 is an exploded side view of a spring booster assembly including a connector according to a second embodiment;

FIG. 7 is an exploded perspective view of a roller blind system;

FIG. 8 is an exploded perspective view of a roller blind system using a connector according to a first embodiment;

FIG. 9 is an exploded perspective view of a roller blind system using a connector according to a second embodiment; and

FIGS. 10, 11, 12, 13, 14 and 15 show various configurations of a roller blind system using one or more connectors.

### DETAILED DESCRIPTION OF THE PREFERRED EMBODIMENTS

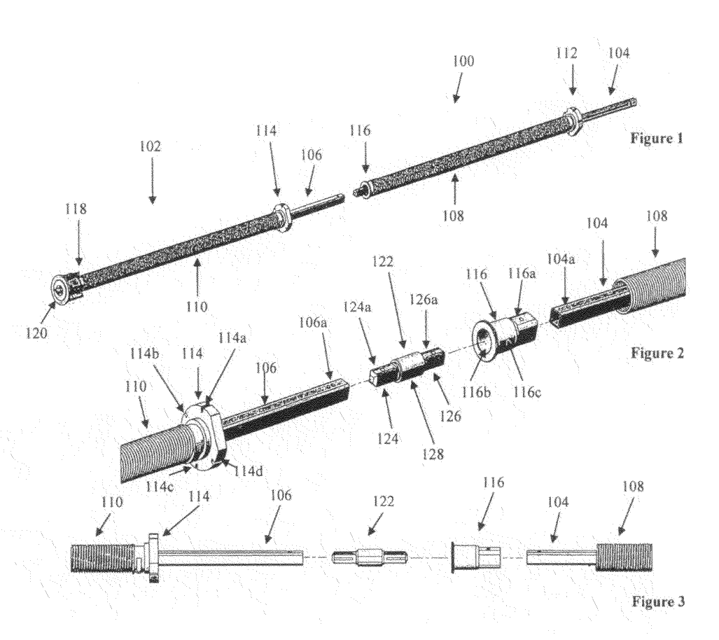

FIG. 1 is a perspective view of two booster assemblies 100 and 102 for use in a roller blind system. Each booster assembly 100 and 112 includes a shaft 104 and 106, a biasing means 108 and 110 (e.g. a coil spring), a connector, and a tail member 112 and 114. An example of a male form of a connector is shown in FIG. 2, which includes an adapter 116 and connecting piece 122. An example of a female form of a connector is shown in FIG. 3, which includes a connecting piece 208. The biasing means 108 and 110 of the booster assemblies 100 and 102 are preferably different coil springs that are wound in a single direction.

The biasing means 108 and 110 fits over the different portions of different shafts 104 and 106. The adapter 116 and 118 engages one end of the biasing means 108 and 110 and holds that end in a fixed position relative to the respective shaft 104 and 106. As shown in FIG. 2, an adapter 116 includes a bore 116b formed through the adapter 116, where one portion of the bore 116b has a cross-sectional shape corresponding to the cross-sectional shape of the shaft 104 to be received in that portion. This enables the bore 116b of the adapter 116 to form a locking fit with an outer surface of the shaft 104 so that the spring adapter 116 can engage and rotate together with the shaft 104. The bore 116b includes another portion that is shaped to receive a connecting piece 122. The adapter 116 includes an outer portion 116c for engaging with the biasing means 108. For example, the adapter 116 may form an interference fit with the biasing means 108 (e.g. by having the outer surface 116c of the adapter 116 threaded for receiving a portion of the biasing means 108). Alternatively, the outer surface 116c of the adapter 116 may include one or more grooves forming a ray section for receiving a correspondingly shaped hook end of the spring.

The tail member 112 and 114 freely rotates about the shaft 104 and 106, and engages the other end of the biasing means 108 and 110. The tail member includes one or more slots 114a, 114b, 114c and 114d for receiving fins formed on the inside surface of a hollow tube (not shown) in which the booster assembly 100 and 102 fits. A flexible sheet material (e.g. fabric) is wrapped around the outside of the tube so that the selective rotation of the tube controls the extension or retraction of the sheet material over a predefined area (e.g. a window).

As shown in FIG. 1, the adapter 118 of at least one spring booster assembly 102 is fitted to a head member 120 that mounts the spring booster assembly 102 to a mounting bracket (not shown). When the tube selectively rotates to extend the sheet material on the tube over a predefined area, the corresponding rotation of the fins inside the tube drives the tail member 112 and 114 to rotate, and this in turn gradually tightens the spring 108 and 110. As the biasing means 108 and 110 gradual tightens, the biasing means 108 and 110 gradually asserts a greater counterbalancing force to assist rotation of the tube in the opposite direction to retract the sheet material onto the tube.

Booster assemblies 100 and 102 can be made from standard components, and can be made in a range of different standard sizes. A cost effective way to produce roller blinds of any size is to allow combinations of standard boost assemblies 100 and 102 to be combined using a connector so that the booster assemblies operate as a single unit.

A connecting piece 122, as shown in FIG. 2, includes a body having a first end portion 126 for fitting into a hollow end portion of a first shaft 104, and a second end portion 124 for fitting into a hollow end portion of a second shaft 106. The first and second shafts 104 and 106 may each be a square tube shaft. Alternatively, the first and second shafts 104 and 106 may be a solid axle including a hollow end portion for receiving the connecting piece 122. When the first and second end portions 124 and 126 of the connecting piece 122 are fitted into the hollow portions of respective the first and second shafts 104 and 106. Accordingly, the rotation of one of the shafts 104 or 106 along its longitudinal axis engages the connecting piece 122 to rotate, whereby rotation of the connecting piece 122 engages the other shaft 104 or 106 to rotate along its longitudinal axis. In the configuration shown in FIGS. 1, 2 and 3, the connecting piece 122 and shafts 104 and 106 rotate along a common axis. The connecting piece 122 is preferably made as a single piece, as shown in FIG. 2.

The first and second end portions 124 and 126 of the connecting piece 122 each have a cross-sectional shape corresponding respectively to the cross-sectional shape of the hollow portion of the first and second shafts 104 and 106, so as to form a close fit for locking engagement when the connecting piece 122 rotates with a respective portion of the shafts 104 and 106.

The cross-sectional shape of the hollow portion of the first and second shafts 104 and 106 is preferably quadrilateral (e.g. a recess with a square-shaped cross-section), although the cross-section of the hollow can have any shape. The cross-section of each of the first and second end portions 124 and 126 has a shape corresponding to the shape of the cross-section of the respective shafts 104 and 106. For example, when the connecting piece 122 is received in the shafts 124 and 126, the outer surface of the end portions 124 and 126 rests adjacent to the corresponding inner surface of the hollow portion of the shaft 104 and 106.

The connecting piece 122 includes an enlarged portion 128 located between the first and second end portions 124 and 126. The cross-section of the enlarged portion 128 of the connecting piece 122 is generally greater than the cross-section of the first and second end portions 124 and 126 so as to minimise movement of said shafts 104 and 106 along the respective end portions 124 and 126 and beyond the enlarged portion 128. The enlarged portion 128 may, for example, have a circular cross-section.

The connecting piece 122 has respective holes 124a and 126a formed through a part of the body of the connecting piece 122 at the first and second end portions 124 and 126. The first and second shafts 104 and 106 each has respective holes 104a and 106a formed through a part of the shaft. When the first and second end portions 124 and 126 are fitted into the hollow portions of the respective shafts 104 and 106, the holes 104a and 106a and recesses 124a and 126a can be linearly aligned for receiving a locking member (not shown) that securely retains the connecting piece 122 to the respective shafts 104 and 106. The locking member may include a pin (such as a split pin or cotter pin).

As shown in FIG. 2, an adapter 116 may include a hole 116a formed through a part of the adapter 116. During assembly of an extensible booster 100, the adapter 116 is fitted over an end portion of the shat 104 so that the holes 116a and 104a are linearly aligned. The connecting piece 122 is passed through the bore of the adapter 116 and fitted into a hollow portion of the shaft 104. The biasing means 108 is fitted over the shaft 104 and made to engage the outer surface of the adapter 116. The tail member 112 is then fitted over the shaft 104 and made to engage the other end of the biasing means 108.

An extensible booster assembly 100 may connect to and engage with another extensible booster assembly 100. Alternatively, an extensible booster assembly 100 may connect and engage with a standard booster assembly 102 for mounting onto a mounting bracket. It can be appreciated that a combination of multiple booster assemblies 100 and 102 can be connected to each other for combined operation as a single booster unit. This enables a roller blind of any length to be easily made simply by combining different booster assemblies with different standard shaft lengths. Also, each assembly 100 and 102 has an independent biasing means (e.g. a spring) so that the combination of multiple boost assemblies can provide a greater combined counterbalancing force for retracting the blind.

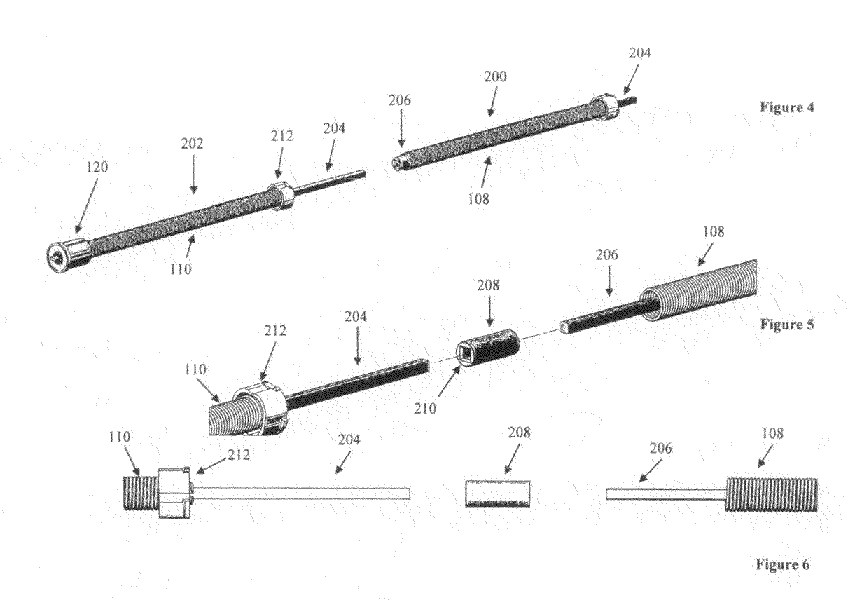

FIGS. 4, 5 and 6 show another embodiment of the connector (including a connecting piece 208) for connecting two solid shafts 204 and 206. As shown in FIG. 5, the connecting piece 208 has a body including a bore 210 formed through the connecting piece 208 along its longitudinal axis. The bore 210 forms two openings on opposite sides of said connecting piece 208. The bore 210 is shaped for receiving a portion of a first shaft 206 and a portion of a second shaft 204. When the connecting piece 208 receives the end portions of the shafts 204 and 206, the rotation of one of the shafts 204 or 206 along its longitudinal axis engages the connecting piece 208 to rotate, whereby the rotation of the connecting piece 208 engages the other shaft 204 or 206 to rotate along its longitudinal axis. In the configuration shown in FIGS. 4, 5, and 6, the connecting piece 208 and shafts 204 and 206 rotate along a common axis. The connecting piece 208 is preferably made as a single piece, as shown in FIG. 5.

The bore 210 has a cross-sectional shape corresponding to the cross-section of said first and second shafts. The connecting piece 208, as shown in FIG. 5, engages with the biasing means 108 in the same way as the adapter 116 of the connector as shown in FIG. 2. The cross-sectional shape of the bore 210 may, for example, be quadrilateral (and preferably square), although it should be understood that the cross-sectional shape should simply correspond with the cross-sectional shape of the shaft, and could be of any shape.

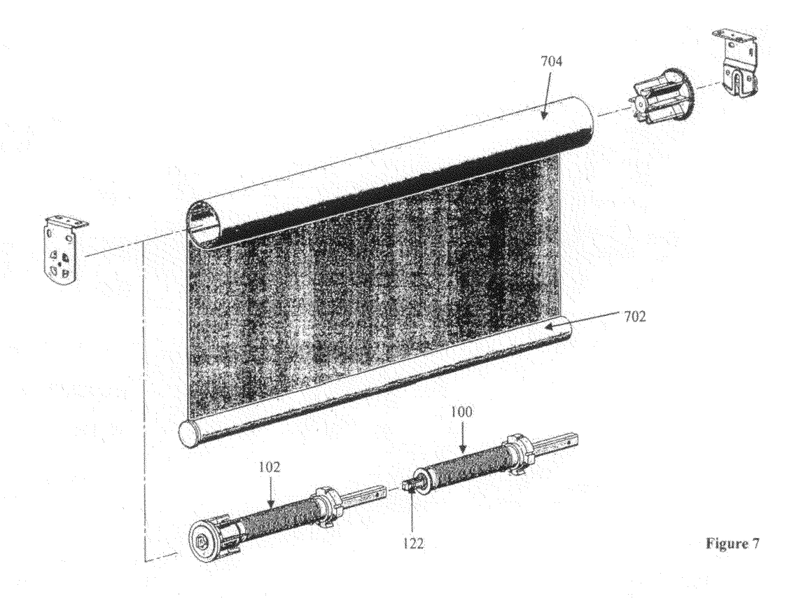

FIG. 7 is an exploded perspective view of a roller blind system incorporating both an extensible and a standard booster assembly 100 and 102 that are engaged to operate together by a connector of the type described with reference to FIGS. 1, 2 and 3 . In this embodiment of a roller blind system, a user gently pulls on a lower portion of the blind 702, and the tube 704 automatically rotates (by the force exerted by the biasing means in the assemblies 100 and 102) in a counter-clockwise direction to retract the blind.

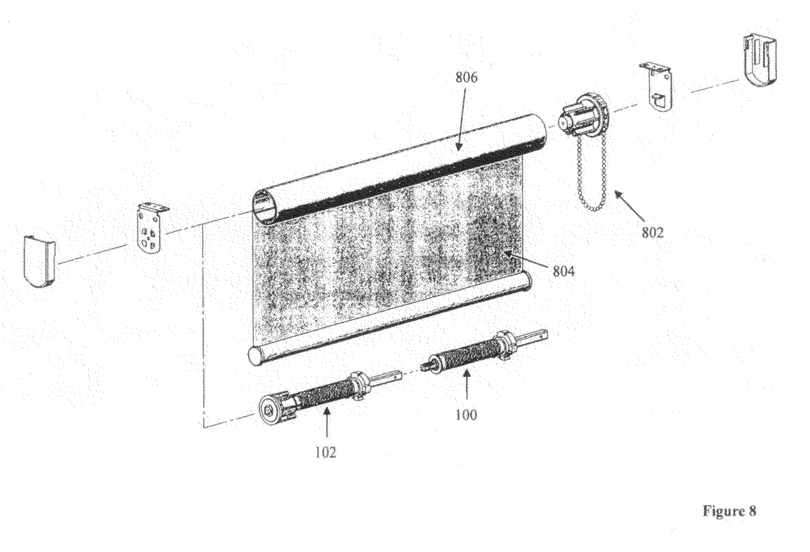

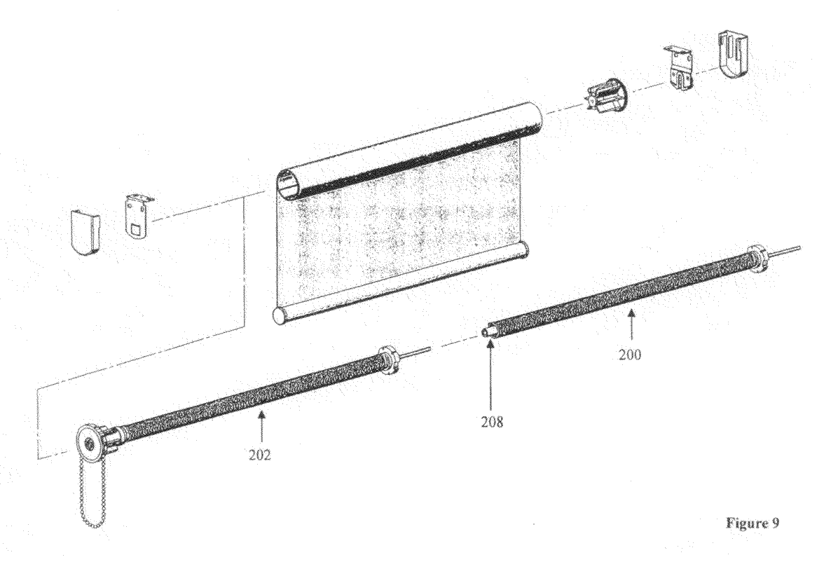

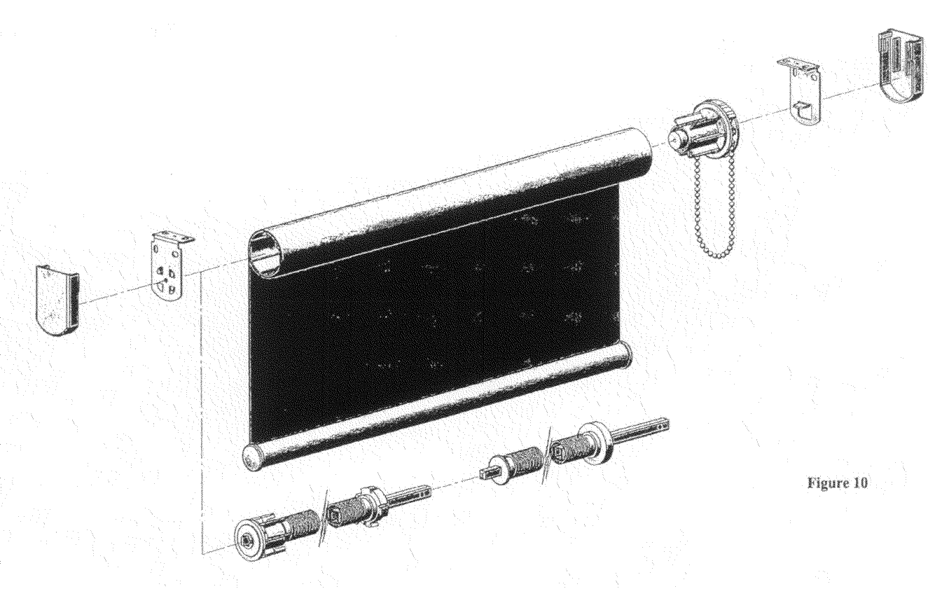

FIG. 8 is an exploded perspective view of another embodiment of a roller blind system incorporating both an extensible and a standard booster assembly 100 and 102 that are engaged to operate together by a connector as describe with reference to FIGS. 1, 2, and 3. This embodiment is similar to the embodiment shown in FIG. 7, except that the raising and lowering of the blind 804 by selective rotation of the tube 806 is controlled by a user operating a chain-driven winder member 802.

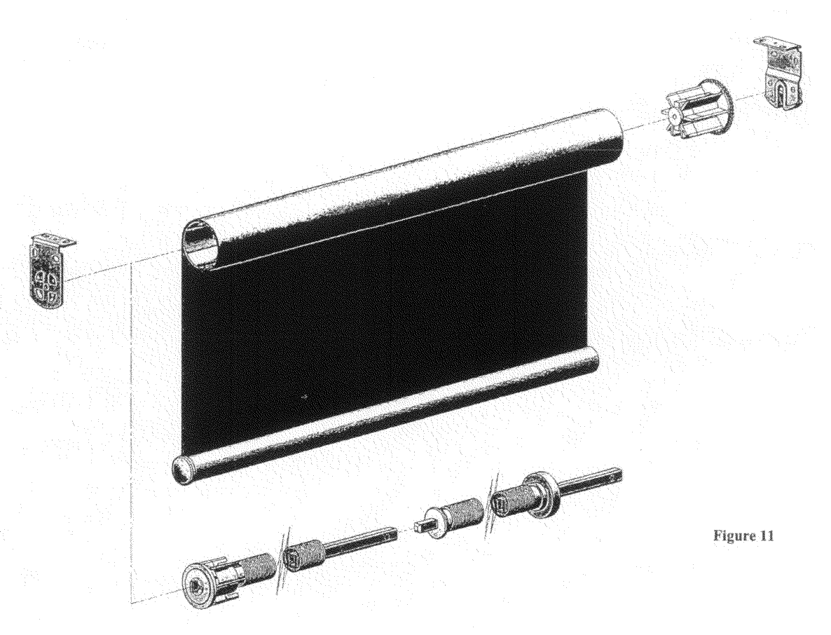

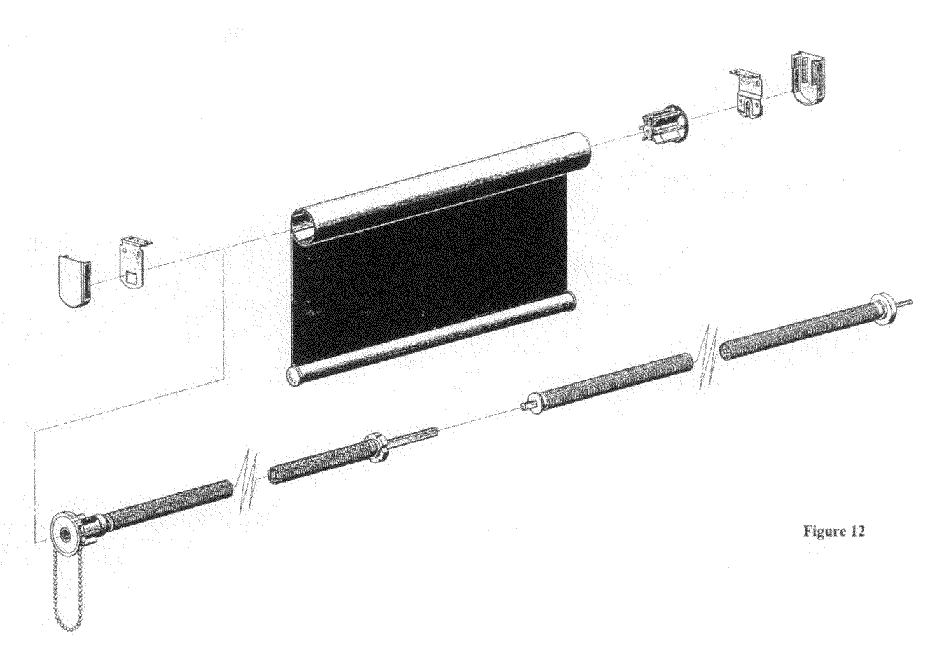

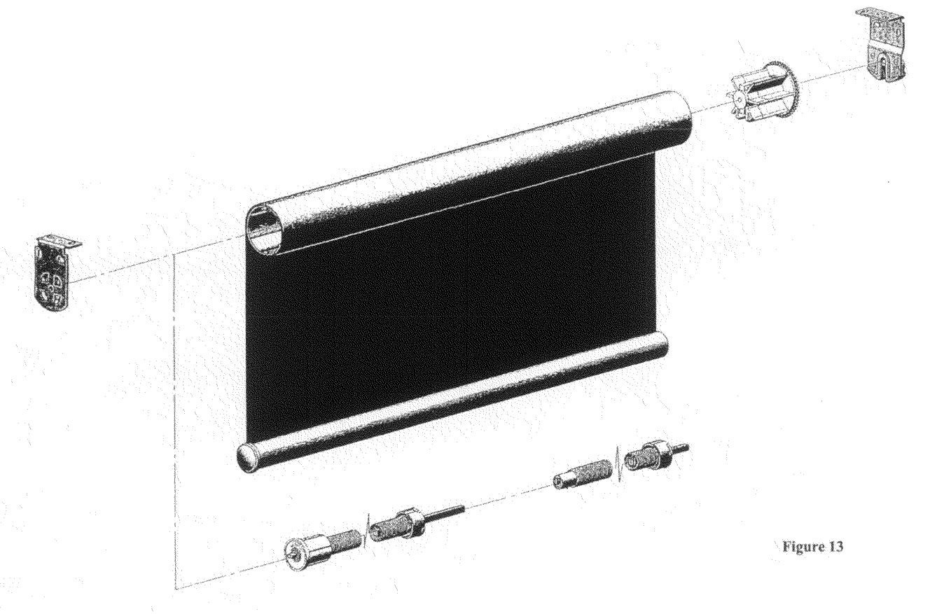

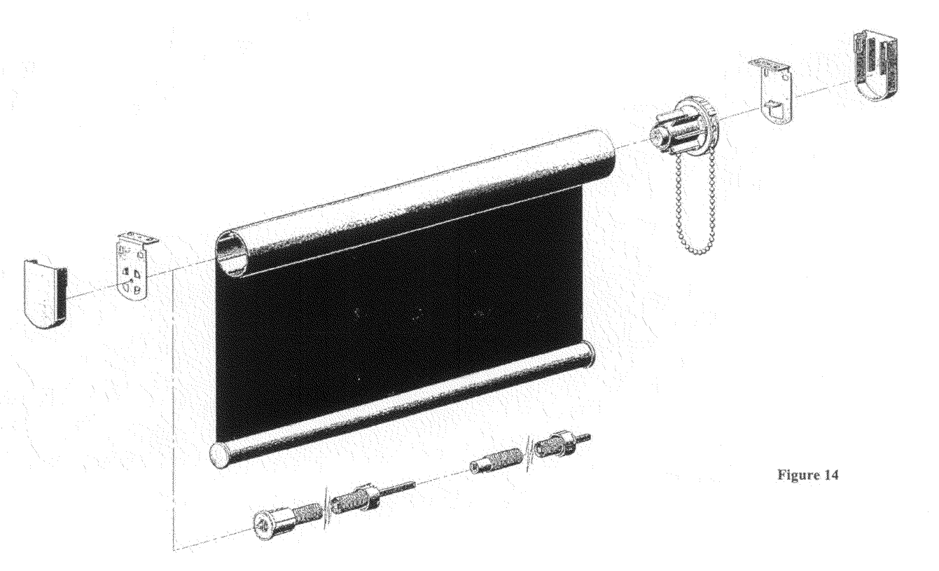

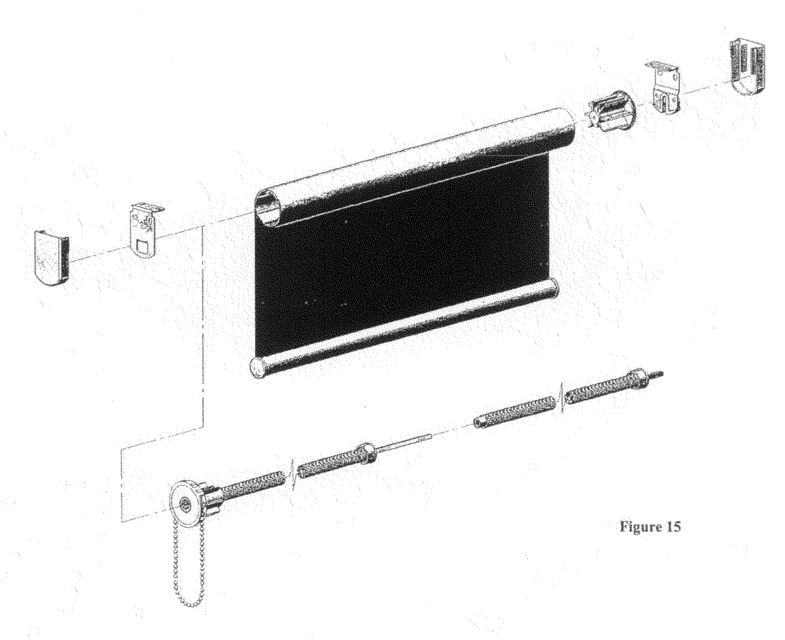

FIG. 9 is an exploded perspective view of another embodiment of a roller blind system incorporating both an extensible and a standard booster assembly 100 and 102 that are engaged to operate together by a connector as describe with reference to FIGS. 4, 5, and 6. The operation of this embodiment is similar to the embodiment described with reference to FIG. 7.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A connector for a blind control mechanism, said mechanism including:
i) a cylinder rotatable relative to two or more different shafts;
ii) drive means connected to the cylinder and being operable to rotate the cylinder in either a blind extending direction or a blind retracting direction; and
iii) at least two biasing means connected to said cylinder, each said biasing means being responsive to rotation of the cylinder in a blind extending direction to store energy and being responsive to rotation of said cylinder in a blind retracting direction to release said stored energy and thereby apply a turning force to the cylinder, said turning force acting in the blind retracting direction;
said connector having a body for coupling an end portion of one of said biasing means to one of said shaft portions, and for coupling respective end portions of two adjacent said shafts together.

2. A connector as claimed in claim 1, wherein said body includes:
a first end portion for fitting into a hollow end portion of a first said shaft;
a second end portion for fitting into a hollow end portion of a second said shaft;
such that, when said first and second end portions are fitted into the hollows of respective said shafts, rotation of one of said shafts along its longitudinal axis engages said body to rotate, whereby rotation of said body engages the other of said shafts to rotate along its longitudinal axis.

3. A connector as claimed in claim 1, wherein said first and second end portions each have a cross-sectional shape corresponding respectively to the cross-sectional shape of the hollow portion of said first and second shafts, so as to form a close fit for locking engagement when said body rotates with said shafts.

4. A connector as claimed in claim 3, wherein the cross-sectional shape of the hollow portion of said first and second shafts is quadrilateral, and the cross-section of said first and second end portions is correspondingly quadrilateral in shape.

5. A connector as claimed in claim 1, wherein said body includes an enlarged portion located between said first and second end portions, the cross-section of said enlarged portion being greater than the cross-section of said end portions so as to minimise movement of said shafts along said body beyond said enlarged portion.

6. A connector as claimed in claim 5, wherein said enlarged portion has a circular cross-section.

7. A connector as claimed in claim 1, wherein said body is made as a single piece.

8. A connector as claimed in claim 1, wherein said first and second shafts are square tubular shafts.

9. A connector as claimed in claim 1, wherein said first and second end portions each respectively has a recess formed into the body, said shafts each respectively having a hole formed therethrough, so that when said first and second end portions are fitted into the hollows of respective said shafts, said holes and said recesses linearly align for receiving a locking member for securely retaining said body to said shafts.

10. A connector as claimed in claim 8, wherein said locking member includes a pin.

11. A connector as claimed in claim 1, wherein said body includes:
a bore formed through said body along its longitudinal axis, said bore leading to openings on opposite sides of said body, wherein said bore is shaped for receiving a portion of a first said shaft and a portion of a second said shaft;
such that, when said body receives said shafts, rotation of one of said shafts along its longitudinal axis engages said body to rotate, whereby rotation of said body engages the other of said shafts to rotate along its longitudinal axis.

12. A connector as claimed in claim 11, wherein said bore has a cross-sectional shape corresponding to the cross-section of said first and second shafts.

13. A connector as claimed in claim 12, wherein the cross-sectional shape of said bore is quadrilateral.

14. An assembly for use in window furnishings including a connector as claimed in claim 1 or 11.

15. A connector for a blind control mechanism, said mechanism including:
i) a cylinder rotatable relative to two or more different shaft portions;
ii) drive means connected to the cylinder and being operable to rotate the cylinder in either a blind extending direction or a blind retracting direction; and
iii) at least two biasing means connected to said cylinder, each said biasing means being responsive to rotation of the cylinder in a blind extending direction to store energy and being responsive to rotation of said cylinder in a blind retracting direction to release said stored energy and thereby apply a turning force to the cylinder, said turning force acting in the blind retracting direction;
said connector having a body for coupling an end portion of one of said biasing means to one of said shaft portions, said connector having an end portion formed for connecting with another of said shaft portions located on a separate shaft.

16. A connector as claimed in claim 15, wherein each of said shaft portions corresponds to a different shaft, and said body of said connector includes:
a first end portion for fitting into a hollow end portion of a first said shaft;
a second end portion for fitting into a hollow end portion of a second said shaft;
such that, when said first and second end portions are fitted into the hollows of respective said shafts, rotation of one of said shafts along its longitudinal axis engages said body to rotate, whereby rotation of said body engages the other of said shafts to rotate along its longitudinal axis.
